(19) United States
(12) Patent Application Publication
(10) Pub. No.: US 2011/0065068 A1
(43) Pub. Date: Mar. 17, 2011

(54) Eyewear Aerodynamic Evaluation Unit

(76) Inventors: Jody Lane Grose, Charlotte, NC (US); Matthew Graham Holland, Salisbury, NC (US)

(21) Appl. No.: 12/557,697

(22) Filed: Sep. 11, 2009

(51) Int. Cl. G09B 25/00

(52) U.S. Cl. 434/126

(57) ABSTRACT

A point-of-sale multi-directional wind simulator will allow customers to evaluate the aerodynamic properties of active eyewear prior to purchase. The invention is configurable in stand-up and countertop configurations.

The device will be positioned at or near the point-of-sale of eyewear counters/displays. The invention will allow customers to assess the effectiveness of their potential eyewear purchase by simulating the air/wind flow commonly experienced on bicycles, boating, motorcycles, skiing, etc.

### FIELD APPLICATION OF THE INVENTION

The Eyewear Aerodynamic Evaluation Unit is an invention/process that will allow customers to evaluate the aerodynamic properties of active eyewear prior to purchase. The Eyewear Aerodynamic Evaluation Unit can also be used for research/design purposes by eyewear manufacturers.

The device will be positioned at or near the point-of-sale of merchant eyewear counters and/or merchant displays. The invention will allow customers to assess the effectiveness of their potential eyewear purchase by simulating the air/wind flow commonly experienced around the eyes while cycling, boating, riding motorcycles, skiing, etc.

### TECHNICAL APPLICATION OF THE INVENTION

The Eyewear Aerodynamic Evaluation Unit will contain single and/or multi-directional fan units that will provide variable wind speeds to simulate conditions encountered during certain activities. The process/device will provide the customer with a general idea of the aerodynamics/functionality of the eyewear. The invention will allow customers to assess the comfort of the eyewear with regards to wind infiltration around the eyes. The invention will be operational in both a stand-up and countertop configurations.

### BACKGROUND

First-hand experience with purchasing eyewear for motorcycle use prompted the idea of creating a process/invention that would allow the customer to verify the functionality of the eyewear before purchase. The device would be located near the store point-of-sale to enable testing and promote potential advertising and marketing opportunities for eyewear vendors and manufacturers.

### FIGURE DESCRIPTIONS ON FOLLOWING PAGE

FIG. 1:

FIG. 1 is a perspective view of the Eyewear Aerodynamic Evaluation Unit countertop design. The invention will be positioned on the counter, at or near the point of sale. The prospective buyer will stand or sit in front of the Eyewear Aerodynamic Evaluation Unit. Air will be directed toward the face of the customer. This will allow the customer to assess their tolerance level of air/wind around the eyewear. The diagram contains illustrations of the fan assembly and adjustment rails.

FIG. 2:

FIG. 2 is a perspective view of the free standing design of the Eyewear Aerodynamic Evaluation Unit. The free standing design will allow the prospective buyer to walk-in/stand in a booth configuration. The customer will place the eyewear on the face. Air will be directed toward the face of the customer. This will allow the customer to assess their tolerance level of air/wind around the eyewear. The diagram contains illustrations of the fan assembly and adjustment rails.

FIG. 3:

FIG. 3 is a side-view of the free standing design of Eyewear Aerodynamic Evaluation Unit. The side-view illustrates the ability to adjust the fan enclosure to accommodate the height of the prospective buyer. The customer will stand in the area in the left portion of the diagram. The adjustable fan assembly is in the center. Air will blow to the right, towards the face of the person. The electrical cord is exiting to the back of the unit, on the right side of the diagram.

FIG. 4:

FIG. 4 illustrates the fan enclosure design for both the countertop and free standing models of the Eyewear Aerodynamic Evaluation Unit. The view of the fan assembly unit is as if you are standing in front of the device. The circular and semi-circle drawings within the unit represent the fan(s). The fan enclosure design is configured in a manner to allow the prospective buyer to adjust the air/wind speed to assess the tolerance level of air/wind around the eyewear.

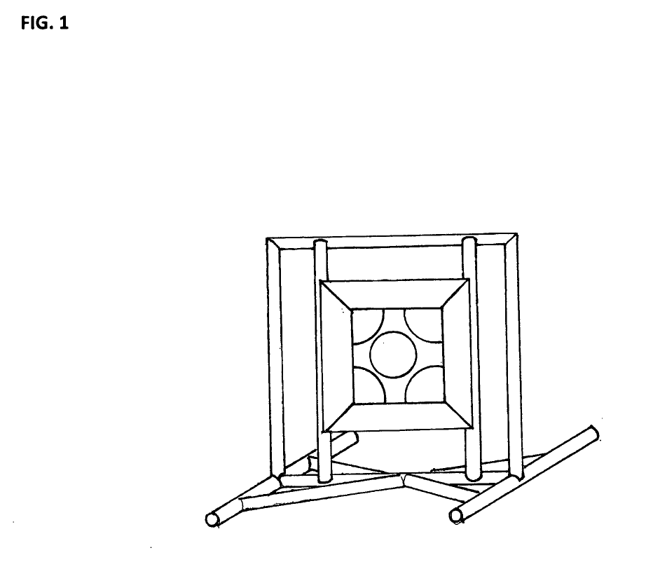

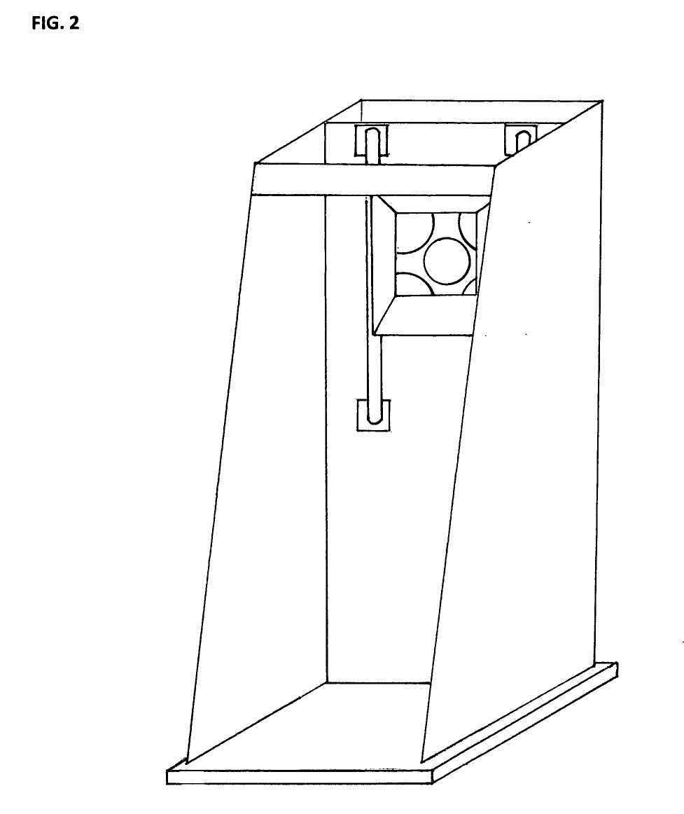

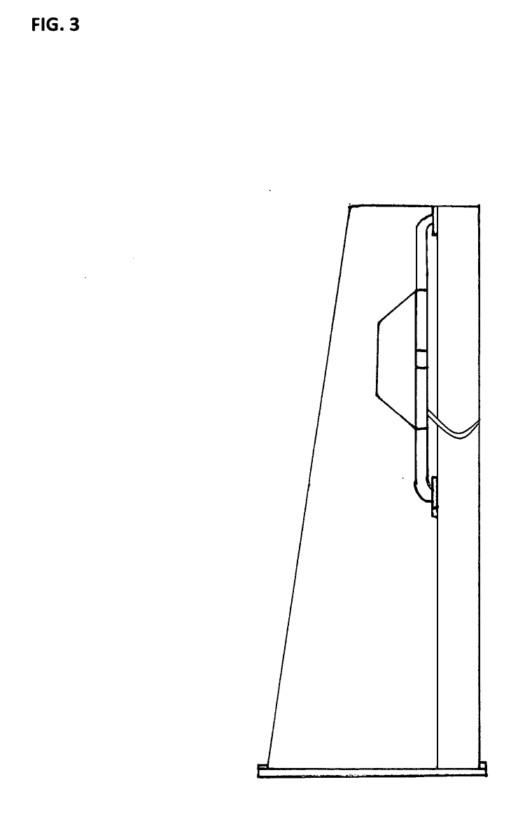

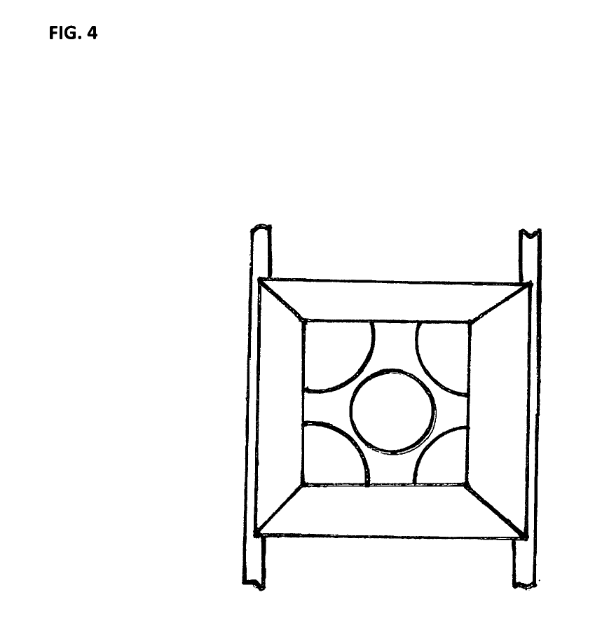

1. The Eyewear Aerodynamic Evaluation Unit will allow consumers to test the air/wind properties of their eyewear prior to purchase. The customers can stand in front of the device and verify whether or not the air/wind will irritate their eye(s).
This will potentially facilitate the increase of sales of active eyewear at retail locations.
